(19) United States
(12) Patent Application Publication
(10) Pub. No.: US 2013/0249315 A1
(43) Pub. Date: Sep. 26, 2013

(54) SWITCHING COMPONENT AND SWITCH SYSTEM COMPRISING THE SAME

(71) Applicant: GENERAL ELECTRIC COMPANY, Schenectady, NY (US)

(72) Inventors: Ronghui Zhou, Shanghai (CN); Fei Xu, Shanghai (CN); Pengju Kang, Shanghai (CN); Tong Zhao, Shanghai (CN); Fei Li, Shanghai (CN); Yong Li, Shanghai (CN); Xiangming Shen, Shanghai (CN)

(73) Assignee: GENERAL ELECTRIC COMPANY, Schenectady, NY (US)

(21) Appl. No.: 13/786,742

(22) Filed: Mar. 6, 2013

(30) Foreign Application Priority Data
Mar. 26, 2012 (CN) 201210082639.X

(51) Int. Cl. H01H 89/00

(52) U.S. Cl. CPC H01H 89/00
USPC 307/113

(57) ABSTRACT

A switching component comprising a number of switch sets in parallel is disclosed herein. Each switch set comprises a number of power switches and a backup power switch in series. The backup power switch has a default position of closed. Rated powers of the power switches and the backup power switch are less than a rated power of the switching component, and the switching component is modular. A switch system comprising the switching component is also described herein.

### BACKGROUND TO THE INVENTION

Embodiments of the present invention relate to a switching component and a switch system comprising the switching component, and more particularly, but not exclusively, relate to a switching component and a switch system comprising a number of power switches with lower rated powers in series and in parallel.

Power switches are widely used in many electric systems. Traditionally, power switches are a single switch element which is switched on or off in circuits to make the circuits closed or open. The electric system often utilizes a number of the power switches, each performing its own function. If any one of the power switches is at fault, the system cannot work to achieve its function. Therefore, the reliability of the system is very low.

### BRIEF DESCRIPTION OF THE INVENTION

Embodiments of the present invention provide a switching component. The switching component comprises a plurality of parallel switch sets. Each switch set comprises a plurality of power switches and a backup power switch in a series. The backup power switch has a default position of closed, wherein a rated powers of the plurality of power switches and the backup power switch are less than a rated power of the switching component. Furthermore, the switching component is modular.

Embodiments of the present invention provide a switching component. The switching component comprises a plurality of power switches formed in a redundant array. A rated power of each of the plurality of power switches is less than the switching component. Furthermore, the switching component is modular.

Embodiments of the present invention provide a switch system. The switch system comprises a switching component, a detection circuitry and a switch controller. The switching component comprises a plurality of power switches formed in a redundant array. A rated power of each of the power switches is less than that of the switching component. The switching component is modular. The detection circuitry is coupled to the switching component to detect the conduction state of each of the power switches and generates a detection signal. The switch controller is coupled to the switching component and the detection circuitry to generate a switch control signal instructing each of the power switches to open or close, based on the detection signal.

### BRIEF DESCRIPTION OF THE DRAWINGS

Features of embodiments of the present invention will become evident from the following description when is taken in conjunction with the following drawings, wherein:

FIG. 1 is a schematic diagram of a switching component in accordance with an embodiment of the present invention;

FIG. 2 is a schematic diagram of the switching component of FIG. 1 in a failed condition, wherein one power switch of the switching component is short-circuited;

FIG. 3 is a schematic diagram of the switching component of FIG. 1 in a failed condition, wherein the power switch of the switching component is open-circuited;

FIG. 4 is a schematic diagram of the switching component in an embodiment of the present invention;

FIG. 5 is a schematic diagram of the switching component of FIG. 4 in a failed condition, wherein one power switch of the switching component is open-circuited;

FIG. 6 is a schematic diagram of the switching component of FIG. 4 in a failed condition, wherein power switches in series of the switching component are all short-circuited;

FIG. 7 is a schematic diagram of the switching component in an embodiment of the present invention;

FIG. 8 is a schematic diagram of the switching component of FIG. 7 in a failed condition; and

FIG. 9 is a schematic diagram of a switch system which utilizes the switching component of FIGS. 1, 4 and 7.

### DETAILED DESCRIPTION OF THE INVENTION

Unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect.

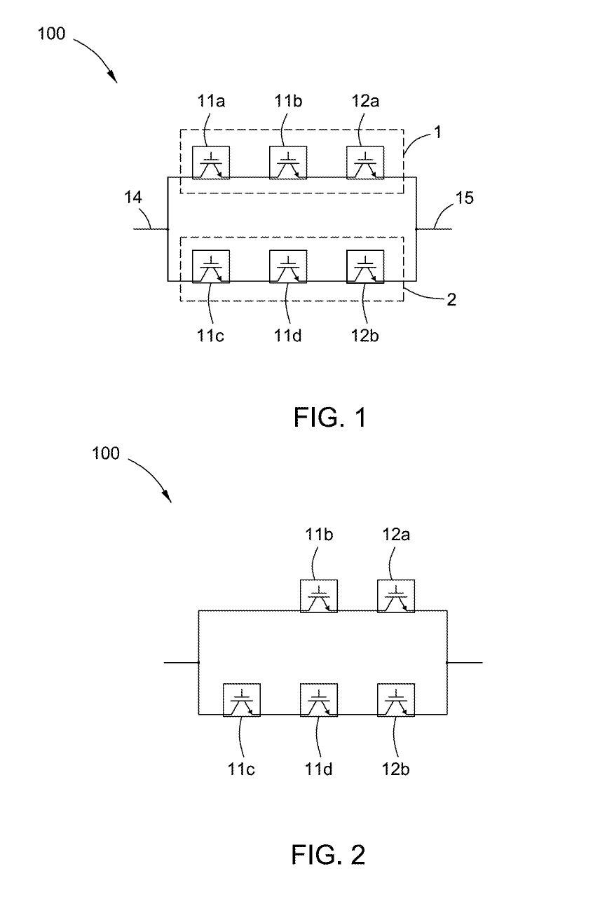

FIG. 1 illustrates a schematic diagram of a switching component 100 in accordance with an embodiment of the present invention. Switching component 100 is modular and has an input terminal 14 and an output terminal 15. Switching component 100 includes two parallel switch sets 1, 2. Each switch set 1, 2 includes two power switches 11a-11d and a backup power switch 12a, 12b in series. Power switches 11a-11d and the backup power switch 12a and 12b are formed in a redundant array. Rated powers of the power switches, 11a-11d, and the backup power switch 12a, 12b are less than a rated power of the switching component 100. In an embodiment, as illustrated in FIG. 2, power switches 11a-11d and backup power switches 12a, 12b are substantially similar, and the rated powers of the power switches, 11a-11d, and backup power switch 12a, 12b are substantially similar as well. In an embodiment of the present invention, the number of the switch set 1, 2, power switches 11a-11d and backup power switch 12a, 12b may change according to particular application environments. For example, the switching component may include more than two switch sets, and each switch set may include more than two power switches and more than one backup power switch.

Power switches 11a-11d are switched on or off simultaneously to determine whether the switching component 100 is opened or closed. Backup power switches 12a, 12b each have a default position of closed and are closed when the power switches 11a-11d work well. FIG. 2 depicts a failure condition where one of the power switches 11a-11d, 11a is short-circuited. In response, backup power switch 12a is switched on or off simultaneously with the power switches 11b-11d to replace the failed power switch, 11a. Since power switches 11c and 11d along with the backup power switch 12b are in normal operating conditions, the backup power switch 12b remains closed. Thereby, switching component 100 may still be switched on and off due to the backup power switch 12a.

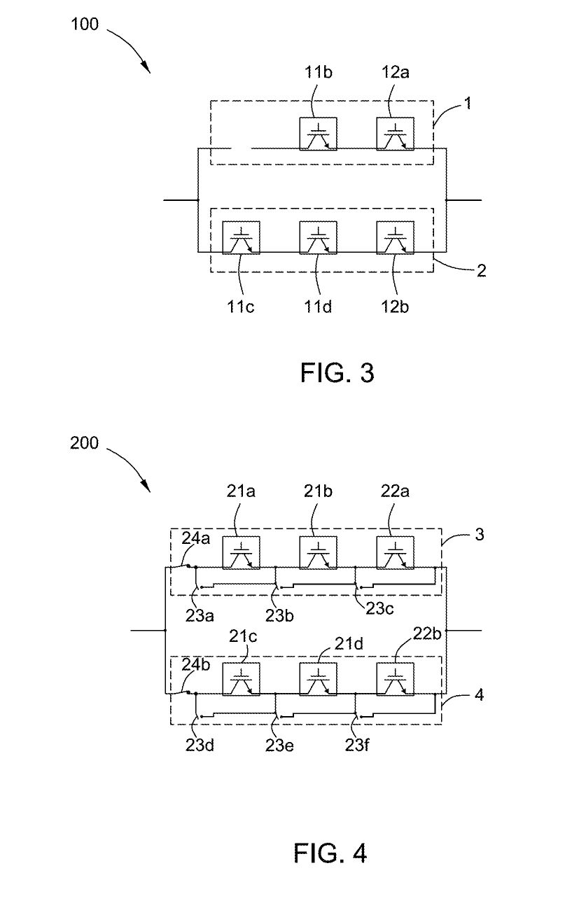

FIG. 3 depicts a failed condition where one of the power switches, 11a-11d, 11a, is open-circuited. Switch set 1 along with power switch 11a fails to work. Switch set 2, which has the power switch 11c, 11d works properly. Power switches 11c and 11d are switched on and off simultaneously and the backup power switch 12a remains closed. Thereby, switching component 100 works well and performs its function.

FIG. 4 illustrates a schematic diagram of switching component 200 in accordance with an embodiment. Switching component 200 includes a number of power switches 21a-21d and backup power switches 22a, 22b. Power switches 21a-21d and backup power switches 22a, 22b are substantially similar and are formed in a redundant array. Switching component 200 includes a number of first auxiliary switches 23a-23f each connecting in parallel with each of power switches 21a-21d and backup power switches 22a, 22b. Each of the first auxiliary switches 23a-23f has a default position of open. When power switches 21a-21d and backup power switches 22a, 22b work well, the first auxiliary switches 23a-23f are open. Each of the switch sets 3, 4 includes second auxiliary switches 24a, 24b connecting in series with power switches 21a-21d and backup power switches 22a, 22b. The second auxiliary switch 24a, 24b has a default position of closed.

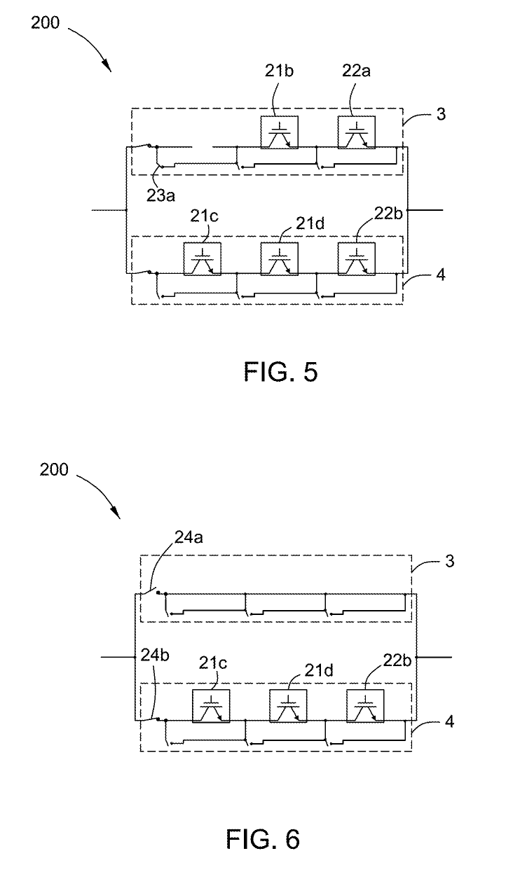

As illustrated in FIG. 5, when power switch 21a is open-circuited, the first auxiliary switch 23a connected in parallel with the power switch 21a is closed, and backup power switch 22a replaces the power switch 21a. So that the switch set 3 with the power switch 21b and the backup power switch 22a may work as well as switching component 200 works well and performs its function. In an embodiment, first auxiliary switches 23a-23f comprises logic switches, such as relay, contactor, et cetera.

As illustrated in FIG. 6, when power switches 21a, 21b and backup power switch 22a of one switch set 3 are both short-circuited at the same time, the second auxiliary switch 24a is switched off. Switch set 4 still works normally, so that switching component 200 still performs its function. In an embodiment of the present invention, second auxiliary switches 24a, 24b comprises a logic switch, such as relay, contactor, et cetera.

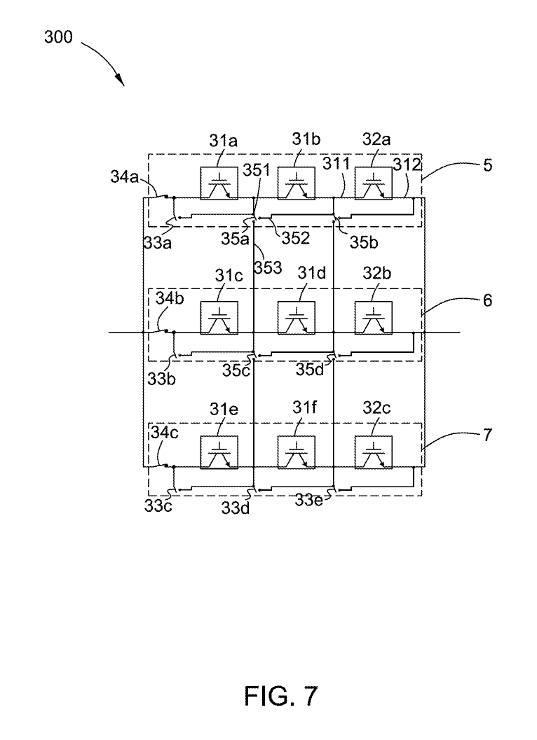

FIG. 7 illustrates a schematic diagram of switching component 300 in accordance with an embodiment. Switching component 300 comprises a number of single-pole double-throw switches 35a-35d each having a common terminal 351 and two separate terminals 352, 353. Power switches 31a-31f and backup power switches 32a-32c each have an input terminal 311 and an output terminal 312. The common terminal 351 and one of the separate terminals 352 connect respectively to the input terminal 311 and the output terminal 312 of power switches 31b, 31d or backup power switch 32a, 32b of one switch set 5, 6. Another separate terminal 353 connects to the input terminal 311 of the power switch 31d, 31f or the backup power switches 32b, 32c of another switch set 6, 7. Each of the single-pole double-throw switches 35a-35d has a default idle state, that is to say, the common terminal 351 does not connect to the two separate terminals 352 and 353. The switching component 300 also has the first auxiliary switches 33a-33e and the second auxiliary switches 34a-34c.

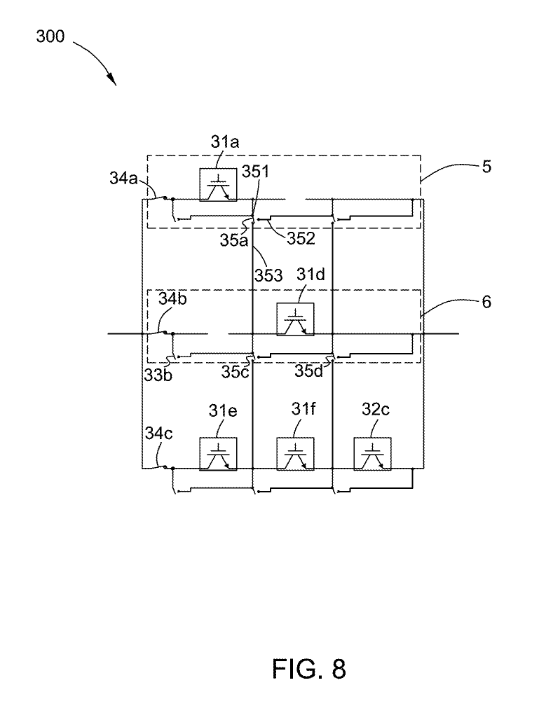

As illustrated in FIG. 8, power switches 31b, 31c and backup power switches 32a, 32b are in faulty condition. Common terminal 351 of the single-pole double-throw switch 35a electrically connects to the separate terminal 353 thereof, so that power switches 31a and 31d of different switch sets 5, 6 form a new switch set.

In an embodiment of the present invention, backup power switches acts as power switches, which switch on and off simultaneously with other power switches. The power switch, the backup power switch, the first auxiliary switch, the second auxiliary switch and the single-pole double-throw switch may be selected and assembled according to different application requirements. Furthermore, the number of the aforementioned switches may change according to the application environment. Power switches with lower rated power, the backup power switches, the first auxiliary switches, the second auxiliary switches and the single-pole double-throw switches are used to enhance the reliability of the switching component and the system using the switching component.

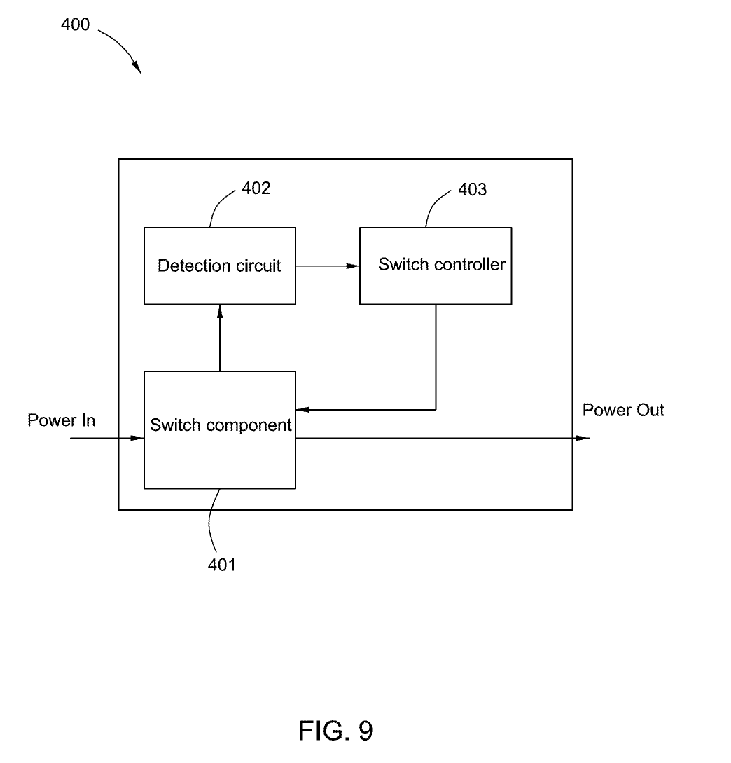

As illustrated in FIG. 9, switch system 400 comprises switch component 401, a detection circuitry 402 coupled to the switching component 401 and a switch controller 403 coupled to switching component 401 and detection circuitry 402. Switching component 401 may be any one of the switching components 100, 200, 300 illustrated in FIGS. 1, 4 and 7. Detection circuitry 402 is configured to detect the conduction state of each of the power switches described above and generate a detection signal indicating the conduction state.

Switch controller 403 is configured to receive the detection signal and generate a switch control signal to instruct each one of the switches, including the power switches, the backup power switches, the first auxiliary switches, the second auxiliary switches and the single-pole double-throw switches based on the detection signal. Switch controller 403 drives the power switches open or closed, set the default positions of the backup power switches, the first auxiliary switches and the second auxiliary switches, drives the backup power switches, the first auxiliary switches, the second auxiliary switches and the single-pole double-throw switches open or closed in the faulty condition state. In an embodiment of the present invention, switch controller 403 comprises a power switch controller (not shown) and a logic switch controller (not shown). The power switch controller drives the power switches. The logic switch controller controls logic switches, including the first auxiliary switches, the second auxiliary switches and the single-pole double-throw switches based on the detection signal to reconfigure the switches of switch component 401 in a faulty condition. In an embodiment of the present invention, the logic switch controller comprises an embedded smart controller.

In an embodiment of the present invention, detection circuitry 402 detects the faulty condition of the power switches and generates a faulty signal. When the faulty signal is received by switch controller 403, switch controller 403 reconfigures the switches to make sure switch component 401 can work in a faulty condition, enhancing the reliability of switch system 400.

While embodiments of the present invention have been described herein, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

Furthermore, the skilled artisan will recognize the interchangeability of various features from different embodiments. The various features described, as well as other known equivalents for each feature, can be mixed and matched by one of ordinary skill in this art to construct additional systems and techniques in accordance with principles of this disclosure.

What is claimed is:

1. A switching component comprising:
a plurality of parallel switch sets, each switch set comprising;
a plurality of power switches and a backup power switch in series, the backup power switch comprises a default position of closed;
wherein a rated powers of the plurality of power switches and the backup power switch are less than a rated power of the switching component; and
wherein the switching component is modular.

2. The switching component of claim 1, further comprising a plurality of first auxiliary switches, wherein each first auxiliary switch connects in parallel with each of the plurality of power switches and the backup power switch, and wherein each of the plurality of first auxiliary switches has a default position of open.

3. The switching component of claim 2, wherein the plurality of first auxiliary switches comprises at least one logic switch.

4. The switching component of claim 1, wherein each of the plurality of switch sets further comprises a second auxiliary switch connecting in series with the plurality of power switches and the backup power switch, wherein the second auxiliary switch has a default position of closed.

5. The switching component of claim 4, wherein the second auxiliary switch comprises at least one logic switch.

6. The switching component of claim 1, further comprising a plurality of single-pole double-throw switches, each single-pole double-throw switch comprising a common terminal and a first and second terminal, wherein the plurality of power switches and the backup power switch each have an input terminal and an output terminal, the common terminal and one of the first and second terminals connect to at least one of the input terminal, the output terminal of the power switch, and the backup power switch of one of the switch sets, and one of the first and second terminals connect to at least one of the input terminals of the power switch and the backup power switch of a different switch set.

7. The switching component of claim 1, wherein rated powers of the plurality of power switches and the backup power switch are substantially similar.

8. A switching component comprising:
a plurality of power switches formed in a redundant array,
wherein a rated power of each of the plurality of power switches is less than the switching component; and
wherein the switching component is modular.

9. The switching component of claim 8, wherein the redundant array further comprises a plurality of first auxiliary switches, each first auxiliary switch connecting in parallel with each of the plurality power switches, and wherein the plurality of first auxiliary switches have a default position of open.

10. The switching component of claim 9, wherein the plurality of first auxiliary switches comprises at least one logic switch.

11. The switching component of claim 8, wherein the redundant array further comprises a plurality of second auxiliary switches connecting in series with the power switches, and wherein the plurality of second auxiliary switches have a default position of closed.

12. The switching component of claim 11, wherein the plurality of second auxiliary switches comprises at least one logic switch.

13. The switching component of claim 8, wherein the redundant array comprises two switch sets in parallel, and each switch set comprising three of the power switches.

14. The switching component of claim 13, wherein the redundant array further comprises a plurality of single-pole double-throw switches, each single-pole double-throw switch comprising a common terminal and a first and a second terminal, wherein the power switches each have an input terminal and an output terminal, and wherein the common terminal and one of the first and second terminals connect to the input terminal and the output terminal of the power switch of the switch set, and one of the first and second terminals connect to the input terminal of the power switch of a different switch set.

15. The switching component of claim 13, wherein at least one of the power switches in each switch set has a default position of closed.

16. A switch system comprising:
a switching component comprising a plurality of power switches formed in a redundant array, a rated power of each of the plurality of power switches being less than that of the switching component, and wherein the switching component is modular;
a detection circuitry coupled to the switching component for detecting the conduction state of each of the plurality of power switches and generating a detection signal; and
a switch controller coupled to the switching component and the detection circuitry for generating a switch control signal to instruct each of the plurality of power switches to open or close, based on the detection signal.

17. The switch system of claim 16, wherein the redundant array comprises two switch sets in parallel, and each switch set comprises three of the power switches.

18. The switch system of claim 17, wherein at least one of the power switches in each switch set has a default position of closed.

19. The switch system of claim 17, wherein the redundant array further comprises a plurality of single-pole double-throw switches, each single-pole double-throw switch comprising a common terminal and a first and second terminal, wherein the power switches each have an input terminal and an output terminal, and wherein the common terminal and one of the first and second terminals connect to the input terminal and the output terminal of the power switch of the switch set, and one of the first and second terminals connect to the input terminal of the power switch of a different switch set.

20. The switch system of claim 16, wherein the redundant array further comprises a plurality of logic switches coupled to the power switches, and the switch controller comprises a power switch controller for driving the power switches and a logic switch controller for controlling the logic switches based on the detection signal.
